(19) United States
(12) Patent Application Publication
(10) Pub. No.: US 2008/0136159 A1
(43) Pub. Date: Jun. 12, 2008

(54) Lifting and Preserving Bloody Impressions for Law Enforcement

(76) Inventor: Jessica Lynn Zarate, Redford, MI (US)

Correspondence Address: REISING, ETHINGTON, BARNES, KISSELLE, P.C., P O BOX 4390, TROY, MI, 48099-4390, US

(21) Appl. No.: 11/952,672

(22) Filed: Dec. 7, 2007

Related U.S. Application Data
(60) Provisional application No. 60/873,470, filed on Dec. 7, 2006.

(51) Int. Cl. B42D 15/00

(52) U.S. Cl. 283/62; 283/67

(57) ABSTRACT

A lifting strip containing titanium dioxide has been successful in the lifting and enhancement of bloody impressions from nonporous and semiporous surfaces. The lifting strip is best when activated with a surfactant. When the lifting strip has dried after application it can easily be removed from the surface lifting the bloody impression onto a contrasting white background for examination. This method is safe, easy, and effective on several nonporous and semiporous surfaces of contrasting colors.

### CROSS-REFERENCE TO RELATED APPLICATION

This application claims priority to U.S. Provisional Patent Application Ser. No. 60/873,470, filed Dec. 7, 2006, which is hereby incorporated by reference.

### TECHNICAL FIELD

The subject invention relates to a method and apparatus for lifting bloody impressions from surfaces at a crime scene.

### BACKGROUND OF THE INVENTION

Bloody impressions are frequently encountered at crime scenes and are of great importance to law enforcement officials. Impressions can include fingerprints, hand prints, palm prints, foot prints, etc. Therefore, developing bloody impressions on various surfaces is of great interest to the forensic science community. Every finger and palm print, for example, has a series of elevated patterns known as friction ridges which are unique to each individual in the population. As a result, if friction ridges can be visualized in blood, they can be used for identification purposes.

When bloody impressions are located on light-colored surfaces they may be photographed directly, which may provide some visualization of ridge structure. But when bloody impressions are located on dark colored surfaces there is usually not enough contrast between the bloody impression and the surface to visualize any ridge structure in the impression. Currently, there are a variety of techniques for enhancing bloody impressions on some non-porous, semi-porous and porous surfaces of varying contrasts, yet they are limited in their effectiveness (Sears and others 2005). These processes require using chemical reagents and are normally conducted in a laboratory setting, which may be both inconvenient and time consuming. Furthermore, immovable objects from crime scenes cannot be brought back to the laboratory for analysis. Many potentially identifiable impressions may only be photographed and not enhanced due to limitations of this nature; and this is not in the best interest of society.

Accordingly, the inventor has seen a need for technology that permits an investigator to lift a bloody impression from a crime-scene surface, and to preserve it for further analysis and use.

### SUMMARY OF THE INVENTION

According to one aspect of the invention, there is a method of lifting bloody impressions including the steps of: providing a strip having titanium dioxide; applying the strip to a bloody impression; applying a surfactant to the strip to interact with the titanium dioxide; drying the strip; and lifting the strip with the bloody impression upon it from the surface.

According to a similar aspect, there is method of lifting bloody impressions including the steps of: obtaining a lifting strip having an impression-lifting side and a backing side, where the impression-lifting side is pre-treated with material for bonding to the bloody impression; applying the impression-lifting side to a bloody impression; wetting the backing side; drying the strip; lifting the strip; and covering the impression-lifting side.

According to another aspect of the invention, there is a strip assembly for lifting and preserving a bloody impression including: a lifting strip having a backing layer and an impression contact layer carried by the backing layer, the impression contact layer including titanium dioxide.

According to yet another aspect, there is a lifting strip assembly for lifting and preserving bloody impressions including a lifting strip having a backing layer and an impression bonding layer carried on the backing layer, the bonding layer including a material adapted to bond with the proteinaceous material in the impression and preserve the impression. There is also a transparent protective layer hingedly attached to the lifting strip whereby the protective layer can be disposed over the bonding layer to cover and protect the impression after it has been lifted.

Other desirable embodiments will occur to those skilled in the art.

### FIGURES IN THE DRAWINGS

The present invention will now be described, by way of example, with reference to the accompanying drawings, in which:

FIG. 1 is a bottom perspective view showing an embodiment of the invention being used to lift a bloody fingerprint;

FIG. 2 is a top perspective view showing an embodiment of the invention with a fingerprint already lifted;

FIG. 3 is a side sectional view taken along lines 3-3 in FIG. 2 showing the layers of an embodiment of the strip; and

FIG. 4 is a similar side sectional view of an alternative embodiment.

### DESCRIPTION OF THE PREFERRED EMBODIMENTS

The present invention will now be described, by way of example, with reference to the accompanying figures in which the lifting strip assembly is generally shown at 10.

The inventor performed a study to determine the effectiveness of a lifting strip containing titanium dioxide for lifting and enhancing bloody fingerprints from a variety of different surfaces when activated with water, methanol, or Kodak Photo-Flo 200™. As described by the relevant Material Safety Data Sheet, titanium dioxide is a non-toxic, non-flammable, fine white powder that is often used as a pigment in paints (MSDS 2006). Due to its non toxic nature, titanium dioxide is ideal reagent for the enhancement and development of bloody and latent fingerprints. Titanium dioxide has shown its effectiveness in other studies in forensic science, where it had been used successfully to enhance bloody fingerprints on dark nonporous surfaces and latent fingerprints on adhesive surfaces (Bergeron 2003; Schiemer and others 2005; Williams and Elliott 2005).

The blood used in this study was obtained from a healthy volunteer donor. The samples of blood were taken intravenously and drawn directly into vacutainers containing anticoagulants by a registered nurse in a medical facility. The blood was refrigerated prior to being used and between uses. Before fingerprint depositions were made using the blood it was warmed to room temperature and shaken vigorously to mix up the contents.

Fingerprints were placed on non-porous, semi-porous and porous surfaces to test the effectiveness of the lifting strip containing titanium dioxide and to determine the quality of the lifted print. The bloody fingerprints were deposited on the various surfaces using the right thumb of the analyst, which had been lightly coated with blood and pressed against the surfaces for a period of ten seconds. The seven surfaces were selected based on their surface type and the fact that they may all be found at a crime scene. The surface items were cut into 2″×2″ squares prior to deposition of the bloody fingerprints. After the bloody fingerprints were deposited on the surface they were left for one hour before the print was lifted using the lifting strip.

Biore® pore strips were used in this study due to their composition, which contains titanium dioxide and their ability to adhere to bloody fingerprints when activated with water, methanol, or Kodak Photo-Flo 200™. Existing Biore Deep Cleaning Pore Strips are covered by one or more of the U.S. Pat. Nos. 5,512,277, 6,299,605, 6,306,382, 6,042,844, 6,221,382 and D 388,534. The teachings of these patents are incorporated herein by reference. Obviously, before the inventor's present work, these pore strips had not been used for the purpose of lifting and preserving bloody impressions. The component in the pore strip largely responsible for its ability to adhere to blood is titanium dioxide, which has effectively been used with methanol to develop bloody fingerprints on dark non-porous surfaces (Bergeron 2003). Each pore strip was cut into three, approximately 1″×1″ pieces, due to the availability of only a limited size strip. The strips are not conducive for lifting any fingerprints larger than this at this time.

The lifting strip comes with a plastic liner that preserves the application side of the lifting strip, and it must be removed before applying the lifting strip to the bloody fingerprint. The lifting strip was applied directly on top of the bloody fingerprint with the shiny application side facing down. The lifting strip will be only slightly tacky when applied to the surface—just enough to prevent the lifting strip from sliding on the surface and possibly altering the bloody fingerprint. The lifting strip must then be activated using one of the reagents chosen in this study.

The reagents chosen in this study were tap water, 100% methanol, and Kodak Photo-Flo 200™. The inventor understands Photo-Flo 200™ to include Propylene glycol (57-55-6) (25-30%) and p-tert-octylphenoxy polyethoxyethyl alcohol (9002-93-1) (5-10%). These reagents were selected based on previous research, where each had been successfully used in activating titanium dioxide for the use in enhancing both latent and bloody fingerprints. (Bergeron 2003; Schiemer and others 2005; Williams and Elliott 2005). To activate the lifting strip, the analyst dipped an index finger in the reagent and then rubbed a minute amount of the reagent over the backside of the lifting strip. The porous backside of the lifting strip must be rubbed thoroughly to affix the bloody fingerprint to the lifting strip. In this study, ten trials were conducted using the above reagents for all seven of the chosen surfaces.

After activating the lifting strip using the above mentioned reagents, the lifting strip must dry completely before the bloody fingerprint can be lifted from the surface in which it had been deposited. Five prints from each of the activating reagents on all seven surfaces were cut in two diagonally. Half of the bloody fingerprints were air dried and half were dried with a blow dryer. The remaining five prints were also cut in two diagonally, but were only air dried.

After the lifting strip and surface were completely dried, the analyst removed the lifting strip from the surface. The best method found for removing the lifting strip was to start in one of the corners and to slowly peel the lifting strip from the surface in which the bloody fingerprint was deposited. The bloody fingerprint was then visibly present on the white background of the lifting strip, providing an inverted version of the bloody fingerprint. At the end of this process, the bloody fingerprint was permanently affixed to the lifting strip.

The analyst took the remaining five bloody fingerprints that were cut in two diagonally and treated one of the sides with ninhydrin using a spray method. Ninhydrin was chosen for this study because it is widely used in the forensic science community and is available in most crime laboratories. (Wallace-Kunkel and others 2004). It is primarily used as an enhancement reagent for latent fingerprints on porous surfaces creating deep purple colored ridge structure in the fingerprint. However, it has also been effective in enhancing bloody fingerprints on light colored surfaces due to its ability to affix to amino acids present in the blood. (Exline and others 2003; Sears and others 2005; Wallace-Kunkel and others 2004)

The overall results of this study were extraordinary on the non-porous and semi-porous surfaces tested. The Kodak Photo-Flo 200™ lifted all proteinaceous material from the non-porous and semi-porous surfaces providing excellent visualization of all the ridge structure present in the bloody fingerprint. The Kodak Photo-Flo 200™ provides the best results for activating the titanium dioxide lifting strip because it is a surfactant. The surfactant is important because it reduces the surface tension during the activation process. Therefore, it is applied smoothly over the backing of the lifting strip, preserving the porous backing, yet providing enough moisture to completely activate the lifting strip. (Schiemer and others 2005). As for the tap water used, it also lifted all proteinaceous material from the non-porous and semi-porous surfaces. Yet, it did not provide the same sharp defined ridge structure as that of the Kodak Photo-Flo 200™. The 100% methanol was also effective, but it did not provide enough moisture during the activation process to allow the lifting strip to completely affix with all the proteinaceous material in the bloody fingerprint. However, it did provide the same defined ridge structure as that of Kodak Photo-Flo 200™. In all trials, the majority of the bloody fingerprint was lifted from the non-porous and semi-porous surfaces using all three reagents, with the Kodak Photo-Flo 200™ providing the best results. (Table 1).

However, the porous surfaces provided less than satisfactory results. Due to the porosity of the surface material, the bloody fingerprints completely saturated the fabrics which provided difficulty during the lifting process. The lifting strips were only able to lift a faint outline of the bloody fingerprints from the porous surfaces with no visible ridge structure present. In all trials the bloody fingerprint remained on the porous surface after the lifting strip was removed.

TABLE 1
Results of lift quality

| | Lift Quality | | |
|---|---|---|---|
| Surfaces | Water | Methanol | Kodak Photo-Flo |
| Nonporous Item #1 | *** | ** | *** |
| Black Plastic Garbage | | | |
| Bag | | | |
| Nonporous Item #2 | *** | ** | *** |
| Light Blue Plastic Folder | | | |
| Semiporous Item #3 | *** | *** | *** |
| Human Skin | | | |
| Semiporous Item #4 | *** | ** | *** |
| Black Leather Belt | | | |
| Semiporous Item #5 | ** | ** | ** |
| Brown Leather Belt | | | |
| Porous Item #6 | * | * | * |
| Grey Polyester Fabric | | | |
| Porous Item #7 | 0 | * | 0 |
| Blue Denim Fabric | | | |

0 = no proteinaceous material, no ridge structure
* = proteinaceous material, no ridge structure
** = proteinaceous material, ridge structure
*** = complete lift all proteinaceous material, ridge structure

The drying times varied in this study, depending on the surface and the reagent that were used. The more porous the surface, the longer it took for the drying process, whether it was air dried or dried with a blow dryer. Also, the more porous the surface, there was an increased level of moisture needed in the lifting strip during the activation process. Increased amounts of moisture on the surface make it difficult to remove the lifting strip without tearing the backing of the strip. The reagent with the quickest drying time was methanol, followed by Kodak Photo-Flo 200™ and then water. Blow drying the items decreased the drying times drastically, but did not provide any further enhancement. (Table 2, 3). The blow drying times given in this experiment were not continuous; they were sporadic throughout the drying process due to time constraints of the analyst.

TABLE 2
Average dry time for blow drying

| | Blow Dried: Average Drying Times | | |
|---|---|---|---|
| | (minutes) | | |
| Surface Porosity | Water | Methanol | Kodak Photo-Flo ™ |
| Non-porous | 8 | 5 | 10 |
| Semi-porous | 60 | 45 | 45 |
| Porous | 68 | 43 | 60 |

TABLE 3
Average dry time for air drying

| | Air Dried: Average Drying Times | | |
|---|---|---|---|
| | (minutes) | | |
| Surface Porosity | Water | Methanol | Kodak Photo-Flo ™ |
| Non-porous | 40 | 15 | 35 |
| Semi-porous (human skin) | 10 | 10 | 10 |
| Semi-porous | 90 | 90 | 90 |
| Porous | 105 | 83 | 98 |

Furthermore, enhancement with ninhydrin was effective in producing greater ridge structure in the bloody fingerprints lifted from the various surfaces tested. However, the ninhydrin reacted with the components of the lifting strip, turning the strip a dark purple color and providing poor contrast for viewing the ridge structure that was previously available.

This study has shown that bloody fingerprints can be effectively lifted from non-porous and semi-porous surfaces using a lifting strip containing titanium dioxide. The reddish-brown ridge structure in the bloody fingerprints provides a nice contrast on the white background of the lifting strip which allows for excellent visualization of the ridge structure present. Therefore, subsequent enhancement after lifting the bloody fingerprints from the surface is not necessary. Also, when the lifting strip is activated, especially with Kodak Photo-Flo 200™, it enhances the quality of the bloody fingerprint, so an optimal quality bloody fingerprint is lifted. When utilizing this technique, bloody impressions can be removed from non-porous and semi-porous immobile objects at crime scenes and from human skin with ease. When the lifting strip is dried, the lifted print becomes permanently affixed to the surface preserving it for future use.

The results from this study will benefit the entire forensic science community. The ability to lift bloody impressions from various contrasting non-porous and semi-porous surface without the need for laboratory equipment or toxic chemicals is both convenient and can be done in a timely manner, especially with the use of a blow dryer to speed up the drying process.

As a result of this study and other investigation, the inventor determined a number of important points. First, the size of the strips needs to be altered to meet the needs of the forensic science community. The strips need to be big enough for lifting bloody fingerprints, bloody palm and foot impressions and bloody footwear impressions encountered at crime scenes. Basically, the strips should come in a variety of sizes including larger sizes.

Second, it is helpful to create a hinge lifting strip for bloody impressions similar to what is currently used for latent fingerprints. This allows the lift to be labeled, easily applied and activated; and it would help preserve the bloody impression for future analysis. Hinge lifting strips are well-known to persons of skill in the field of forensic science. They include an adhesive backed lifting film which comes with a lifting card. To use the hinge lifter, the lifting film is peeled from the lifting card, but a part of the film portion remains attached to the card on one end, thus forming a “hinge.” The lifting film is then applied to the surface to lift the latent print. The lifting film is pressed over the latent print and the print is lifted onto the film, which is then preserved with the backing card for future analysis. They also come with an area to label or diagram the location of the print. Hinge lifting strips for latent fingerprints are commercially available. Brand names include Sirchie® and BVDA. But the hinge lifters for latent fingerprints need to be modified in accordance with the teachings of the invention, which involves lifting bloody impressions (e.g. using titanium dioxide).

Third, the backing on the commercially available Biore lifting strip could be more durable. It degrades easily if too much moisture is added, destroying the lifting strip and impression during the lifting process. Therefore, one should alter the backing on the strip to create a more durable backing. Yet, a material should be selected to keep the backing material porous so the strip can still be easily activated without the possibility of altering or destroying the print.

Fourth, it is beneficial to increase the amount of titanium dioxide in the lifting strip to see if that would improve the quality of the bloody impressions lifted from various surfaces. The titanium dioxide is disposed in the impression layer of the lifting strip. The titanium dioxide comprises about 2 weight percent of that layer. The lifting qualities of the impression layer will increase with increases in the concentration of titanium dioxide.

An embodiment of the invention was used to lift bloody fingerprints off of seven surfaces. Two were nonporous: black plastic trash bags and a blue translucent folder. Three were semi-porous surfaces: human skin, black and brown leather. Two were porous items: grey polyester fabric and blue denim. There were 30 lifts from each sample. 10 lifts for each surface were activated with water, 10 were activated with methanol, and 10 were activated with Photo-Flo™—all of which activate titanium dioxide. Photo-Flo™ provided the best results. Five of the prints from each activation method were cut in half after activation. The top half was air dried and the bottom half was blown dry. The remaining five prints were also cut in half with the top half remaining as is and the bottom enhanced further with ninhydrin. The blow dryer is very effective in reducing the dry time before the lift can be removed.

Referring to the figures, one can see a preferred embodiment generally shown at 10. It includes a strip assembly for lifting and preserving bloody impressions including a lifting strip generally indicated at 12 having a backing layer 14, and an impression contact or impression bonding layer 16 carried by the backing layer, with the impression contact layer including titanium dioxide.

The pigment content in the impression contact layer 16 can range from 0.01 to 70% by weight based on the total weight of the ingredients in the impression contact layer 16. Possible pigments/extenders other than titanium dioxide (which has already been mentioned) include zinc oxide, silica, sericite, and kaolin.

The impression contact layer 16 typically includes enough titanium dioxide to bond with the bloody impression. In one embodiment, there is an amount ranging from about 2 weight percent and higher. The titanium dioxide is mixed with a variety of other ingredients as indicated in Example 8 disclosed in U.S. Pat. No. 6,306,382, the teachings of which are incorporated herein by reference. The ingredients can include, for example: polymethacryloyloxy trimethyl ammonium chloride (QDM) (MW: 200,000)—15.0 wt. %; polymethacrylamidepropyl trimethyl ammonium chloride (MAPTAC) (MW: 300,000)—15.0 wt. %; polyoxyethylene hydrogenated castor oil (E.O. 40)—1.5 wt. %; Squalene—0.5 wt. %; 2-ethylhexanoic triglyceride—2.0 wt. %; sorbitol—3.0 wt. %; kaolin—7.0 wt. %; titanium dioxide—2.0 wt. % and higher; ethanol—5.0 wt. %; antiseptic—suitable amount; and water—balance.

The polymer content of the impression contact layer 16 can affect the strength and durability of the contact layer. The amount of polymer in the impression contact layer 16 can range from 0.01 to 70% by weight based on the total weight of the ingredients in the impression contact layer 16. It may be desirable in some embodiments to have this polymer content range as high as 40% or higher to increase the strength and durability of the contact layer 16.

The assembly further includes a cover 18 for covering the impression contact layer 16. The cover 18 is some suitable clear plastic.

The assembly further includes a hinge 20 interconnecting the lifting strip and the cover. The hinge 20 may desirably include a strip where a legend or writing can be applied to describe or label the strip with a date, location, or other useful information.

The backing layer 14 is light in color (e.g. white) to provide a contrasting background for the bloody impression to be lifted. The backing layer 14 includes hydrophobic material and hydrophilic material. In one embodiment, these materials may be combined into a single layer as shown in FIG. 3. In another embodiment, the hydrophobic material and hydrophilic material are in substantially separate layers 22 and 24, respectively, as shown in FIG. 4. Specific materials that can be used are set forth in U.S. Pat. Nos. 6,042,844 and 6,306,382, the teachings of which are incorporated herein by reference. Common hydrophobic materials are plastics and plastic fibers. Common hydrophilic materials are natural fibers like cotton, flax and wool.

The porosity of the backing layer 14 is, in one embodiment, less than 70%. The porosity is represented by the following equation:

Porosity (%)=(ρ−ρ′)×100/ρ

wherein ρ is a specific gravity of the backing layer 14, and R′ is an apparent specific gravity of the backing layer 14. The explanation for this embodiment is that there is a tradeoff between permeability and strength. Backing layers that are more porous tend to be more permeable, but not as strong. In some embodiments, it may be desirable to have a stronger backing layer. This may increase the drying time, but that could be a worthwhile tradeoff.

The thickness of the backing layer 14 can range from 40 to 2000 μm. This can be divided fairly evenly between the two sub-layers 22, 24 if there are any. In some embodiments it could be desirable to increase the thickness above 2000 μm to increase the strength of the backing layer.

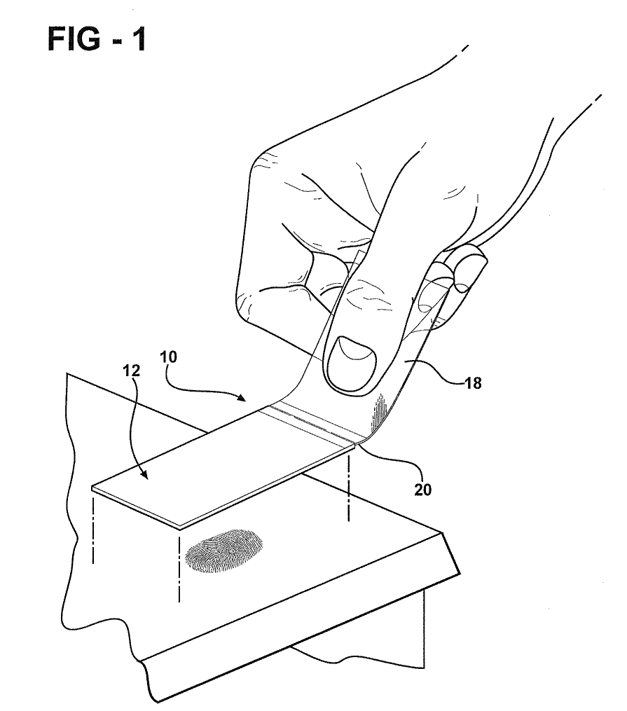

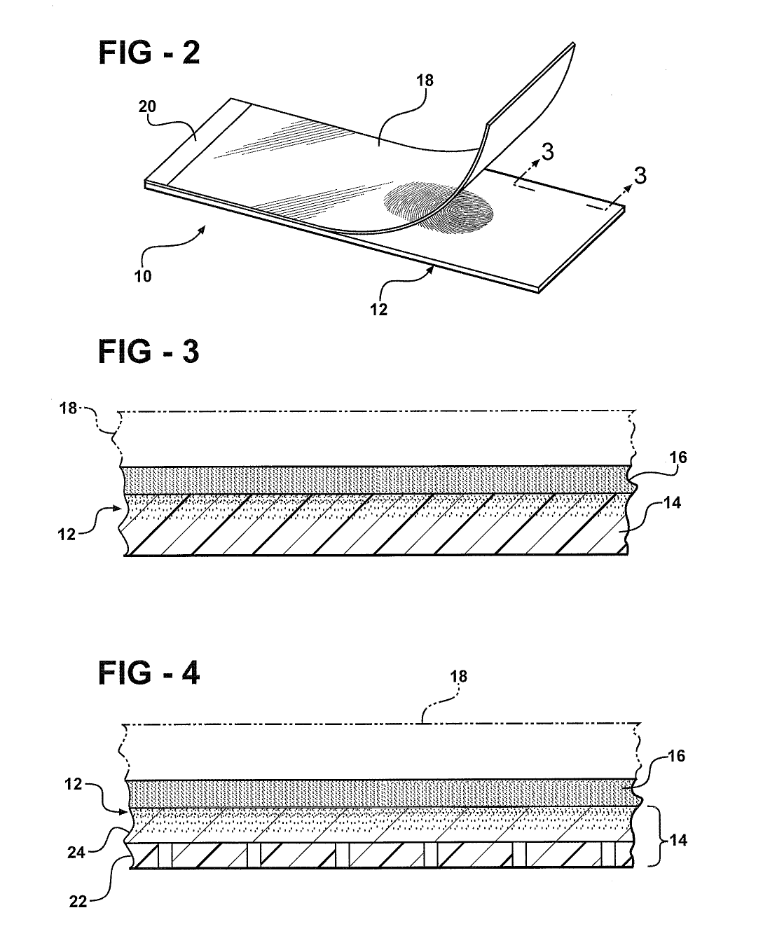

The use of the strip assembly 10 is illustrated in part in FIG. 1. An investigator can first obtain a strip assembly 10 and peels back the cover 18. Next, the investigator applies the strip to a bloody impression (e.g. a fingerprint). Then the investigator applies a surfactant like Photo-Flo 200™ to the backing layer 14 to interact with the materials in the impression contact layer 16. Then the investigator dries the strip, either with air drying or with a blow dryer. Finally, after drying, the investigator can lift the strip carefully and replace the cover 18 to protect the impression. The impression can be labeled and taken to a lab for analysis, and possibly used as evidence.

Obviously, many modifications and variations of the present invention are possible in light of the above teachings. Therefore, it is to be understood that within the scope of the appended claims the invention may be practiced otherwise than as specifically described. Moreover, the reference numerals are merely for convenience and are not intended to be in any way limiting.

1. A method of lifting bloody impressions including the steps of:
providing a strip having titanium dioxide;
applying the strip to a bloody impression;
applying a surfactant to the strip to interact with the titanium dioxide;
drying the strip; and
lifting the strip.

2. The method of claim 1 further including the step of covering the impression after lifting it.

3. The method of claim 1 wherein the lifting step includes starting in one of the corners and peeling the lifting strip from the surface in which the bloody impression was deposited.

4. The method of claim 1 wherein the surfactant is a solution including propylene glycol and an alcohol.

5. A strip assembly for lifting and preserving bloody impressions including:
a lifting strip having a backing layer and an impression contact layer carried by the backing layer, the impression contact layer including titanium dioxide.

6. The assembly of claim 5 wherein the impression contact layer includes titanium dioxide in an amount ranging from about 2 weight percent and higher.

7. The assembly of claim 5 wherein the titanium oxide is mixed with an extender.

8. The assembly of claim 7 wherein the extender includes kaolin.

9. The assembly of claim 5 wherein the backing layer is light in color to provide a contrasting background for the bloody impression to be lifted.

10. The assembly of claim 9 wherein the backing layer is white.

11. The assembly of claim 5 further including a cover for covering the impression contact layer.

12. The assembly of claim 11 further including a hinge interconnecting the lifting strip and the cover.

13. The assembly of claim 5 wherein the backing layer includes hydrophobic material and hydrophilic material.

14. The assembly of claim 13 wherein the hydrophobic material and hydrophilic material are in substantially separate layers.

15. The assembly of claim 5 wherein the porosity of the backing layer is less than 70%.

16. A lifting strip assembly for lifting and preserving bloody impressions including:
a lifting strip including a backing layer and an impression bonding layer carried on the backing layer, the bonding layer including a material adapted to bond with the proteinaceous material in bloody impressions and preserve the impression intact; and a transparent protective layer hingedly attached to the lifting strip whereby the protective layer can be disposed over the bonding layer to cover and protect the impression after it has been lifted.

17. The lifting strip of claim 16 wherein the bonding layer includes a pigment.

18. The lifting strip of claim 17 wherein the pigment is titanium dioxide.

19. The lifting strip of claim 16 wherein the backing layer has a thickness that is at least 2000 μm.

20. A method of lifting bloody impressions including the steps of:
obtaining a lifting strip having an impression-lifting side and a backing side, where the impression-lifting side is pre-treated with material for bonding to the bloody impression;
wetting the backing side;
applying the impression-lifting side to a bloody impression;
drying the strip;
lifting the strip; and
covering the impression-lifting side.
